(19) United States
(12) Patent Application Publication
(10) Pub. No.: US 2018/0153134 A1
(43) Pub. Date: Jun. 7, 2018

(54) PET BED SYSTEMS

(71) Applicant: Hannah Hedley, Maple Ridge (CA)

(72) Inventor: Hannah Hedley, Maple Ridge (CA)

(21) Appl. No.: 15/366,734

(22) Filed: Dec. 1, 2016

(51) Int. Cl. A01K 1/035; A01K 29/00; A47G 29/00; A01K 1/02

(52) U.S. Cl. CPC A01K 1/0353; A01K 1/0236; A47G 29/00; A01K 29/00

(57) ABSTRACT

A pet bed system for a pet to use as a pet bed which also includes storage for paperwork, extra toys, clothes, and the like. The pet bed system lessens the amount of space needed for the pet's belongings and keeps all the documentation in a secure location. Three specific compartments contain all paperwork, toys accessible to the pet, and a hidden storage area for items such as harnesses, leashes, and pet waste disposal bags. The pet bed system is transportable so that all items familiar to the pet along with proper documentation can travel with ease. The pet bed system can suit the needs of small and especially large breeds alike.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pet care and more specifically relates to a pet bed system for containing all items needed for the care of a pet.

### 2. Description of Related Art

Pets are an integral part of many families Individuals with pets often want to give them the best possible care, and pets are regularly given items specifically for their enjoyment. While pets can sometimes generally take care of themselves, the owners still have certain items that are necessary for the proper care and maintenance of an animal. Paperwork is required for pedigree breeds, along with any paperwork from the veterinarian regarding treatment of an animal. Should an owner decide to travel with their pet, all necessary documentation and items familiar to the pet are needed for the journey. A suitable solution is desired.

Several attempts have been made to solve the above-mentioned problems such as those found in U.S. Pub. No. 2005/0072364 to Nancy Kerrigan; 2007/0193511 to Lori Greschler; 2014/0238891 to Melissa Tagliamonte et al.; 2005/0120968 to Natalie Dorsey; 2006/0118051 to Frank Lima; 2007/0028854 to Shivan Chem; 2006/0288953 to Cheryl Bottorff; U.S. Pat No. 6,516,745 to Donna K. Spires et al.; U.S. Pat. No. 8,662,014 to Alisa F. Harrell; U.S. Pat. No. 6,907,842 to Donald E. Godshaw; and U.S. Pat. No. 5,479,892 to Myitis C. Edwards. This art is representative of pet care. However, none of the above inventions and patents, taken either singly or in combination, is seen to describe the invention as claimed.

Preferably, a pet bed system should provide storage for all the items needed by a pet and, yet would operate reliably and be manufactured at a modest expense. Thus, a need exists for a reliable pet bed system to avoid the above-mentioned problems.

### BRIEF SUMMARY OF THE INVENTION

In view of the foregoing disadvantages inherent in the known pet care art, the present invention provides a novel pet bed system. The general purpose of the present invention, which will be described subsequently in greater detail is to provide a pet bed assembly which stores and transports all necessary documentation and items familiar to a pet.

A pet bed system is disclosed herein, in a preferred embodiment, comprising: a pet bed assembly comprising; a frame defined by a first-compartment, a second-compartment, a third-compartment; a base defined by a first-side, a second-side, a third-side, and a fourth-side; wherein the pet bed system comprises the pet bed assembly. The frame defines an area for bedding material to be used by the pet. The pet bed assembly is preferably constructed from rigid plastic such that the pet bed assembly is easy to clean via wiping, and is durable and washable in use. The first-compartment comprises a crescent-shaped toy storage providing easy access to toys, and a lid which opens from a bottom of the base for ease of access to pet toys. The lid comprises a removable hinge such that the lid detaches from the crescent-shaped toy storage for ease of cleaning. Further, the lid comprises the removable hinge such that the lid detaches from the crescent-shaped toy storage for replacement.

The second-compartment is hidden within the frame for storage of medication prescribed to a pet, and wherein the second-compartment is constructed as a false bottom for storing extra blankets, a raincoat of the pet, a harness of the pet, clothing suitable for wear by the pet, a leash for the pet, waste disposal bags for use by the pet and the like. In the false bottom and removable lid, a groove for your hand provides a grip and means for easier access. The second-compartment is disposed above a plane of the third-compartment within the frame. The third-compartment comprises a reseal-able plastic envelope suitable to contain paperwork for the pet which is flush with the frame to prevent accidental removal by the pet. The third-compartment containing the reseal-able plastic envelope stores an entirety of records for the pet, and protects the entirety of records for the pet. The pet bed assembly, the frame, and the base are structured and arranged to provide a complete storage system for the pet which is transportable from place to place with all necessities needed by the pet with the exception of food and water.

The pet bed system kit is also disclosed herein including: a pet bed assembly, a lid to cover toy storage, a reseal-able plastic envelope, a set of bedding, and a set of user instructions.

A method of using a pet bed system is also disclosed herein, comprising the steps of: teaching a pet to sleep in a pet bed assembly, teaching the pet where to find and access toys on the pet bed assembly, storing items related to the pet in three designated compartments, and transporting the pet bed assembly with the pet when needed. The method may further comprise the step of: cleaning the pet bed assembly as needed.

The present invention holds significant improvements and serves as a pet bed system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, pet bed systems, constructed and operative according to the teachings of the present invention.

FIG. 1 shows a perspective view illustrating a pet bed system during an ‘in-use’ condition showing a pet using bedding material on a pet bed assembly with a hidden storage compartment, a toy storage compartment, and a paperwork storage compartment according to an embodiment of the present invention.

FIG. 2 is an exploded view illustrating the pet bed system comprising the hidden storage compartment, the toy storage compartment with a lid detached, and the paperwork storage compartment according to an embodiment of the present invention of FIG. 1.

FIG. 3 is a perspective view illustrating the pet bed system showing the lid of the toy storage compartment in an open position according to an embodiment of the present invention of FIGS. 1-2.

FIG. 4 is a perspective view illustrating the pet bed system showing the paperwork storage compartment resealable plastic envelope according to an embodiment of the present invention of FIGS. 1-3.

FIG. 5 is a flowchart illustrating a method of use for the pet bed system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to pet care and more particularly to a pet bed system as used to improve a pet bed assembly which stores and transports all necessary documentation and items familiar to a pet that travels with the pet when needed.

Generally speaking, pet beds have remained the same for a very long time but our relationship with our pets has evolved. Most household pets have more than one chewed up toy as their sole possession. Pets have need of items very similar to a person, for example: pedigree papers; licence documents; veterinarian papers; insurance papers; tracking chip papers; passport; certificates; medication; toys; raincoats; winter coats; sweaters; t-shirts; costume clothing; leashes; harnesses; barking collars; poop bags; etc. People are adjusting to living in smaller living areas. As population grows, houses, apartments, and condos become smaller and smaller impacting the amount which can be stored in the space. Should a pet owner decide to bring their pet on a trip with them, the whole unit can be easily transported with everything the pet needs, just add food and water.

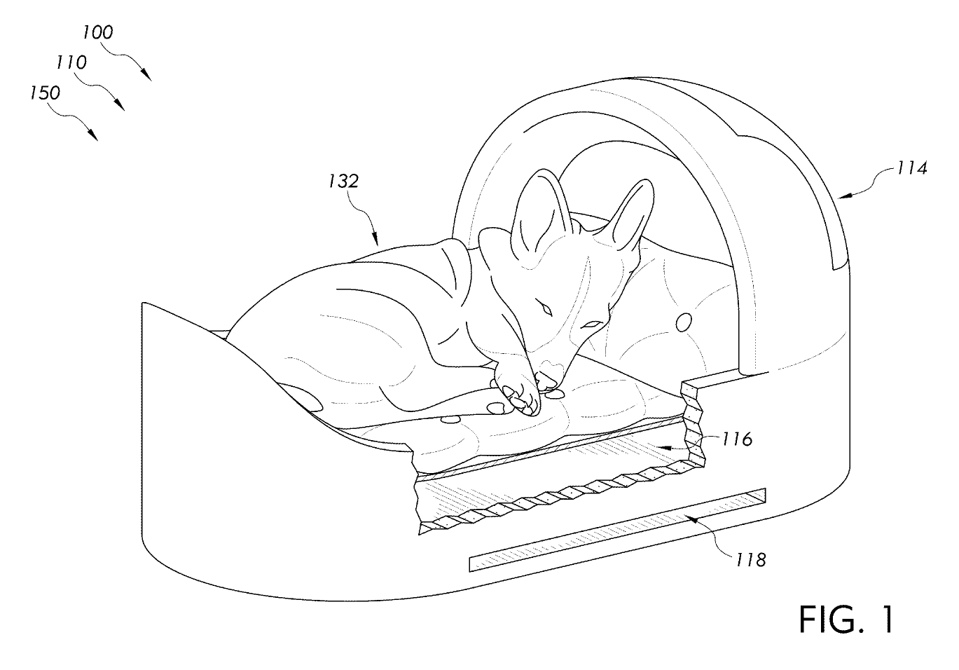

Referring to the drawings by numerals of reference there is shown in FIG. 1, pet bed system 100 comprising: pet bed assembly 110 comprising frame 112 defined by first-compartment 114, second-compartment 116, third-compartment 118; base 120 defined by first-side 122, second-side 124, third-side 126, and fourth-side 128; wherein pet bed system 100 comprises pet bed assembly 110. First-compartment 114 comprises crescent-shaped toy storage 130 providing easy access to toys. Second-compartment 116 is hidden within frame 112 for storage of medication prescribed to pet 132. Third-compartment 118 comprises resealable plastic envelope 134 suitable to contain paperwork 136 for pet 132 which is flush with frame 112 to prevent accidental removal by pet 132. As such, pet bed assembly 110, frame 112, and base 120 are structured and arranged to provide a complete storage system for pet 132 which is transportable from place to place with all necessities needed by pet 132.

Crescent-shaped toy storage 130 comprises lid 138 which opens from a bottom of base 120 for ease of access to pet toys. Lid 138 comprises removable hinge 142 such that lid 138 detaches from crescent-shaped toy storage 130 for ease of cleaning, and detaches from crescent-shaped toy storage 130 for replacement. Third-compartment 118 containing reseal-able plastic envelope 134 stores an entirety of records and protects the entirety of records for pet 132. Second-compartment 116 is constructed as a false bottom for storing extra blankets, clothing suitable for wear by pet 132, a leash for pet 132, a raincoat of pet 132, a harness of pet 132, and waste disposal bags for use by pet 132. Pet bed assembly 110 is constructed from rigid plastic 144 such that pet bed assembly 110 is easy to clean via wiping, and is durable and washable in use. Frame 112 defines an area for bedding material 146. Second-compartment 116 is disposed above a plane of third-compartment 118 within frame 112.

Pet bed system 100 may be sold as kit 440 comprising the following parts: at least one pet bed assembly 110; at least one lid 138 to cover crescent-shaped toy storage 130; at least one reseal-able plastic envelope 134; at least one set of bedding material 146; and at least one set of user instructions 165. The kit has instructions such that functional relationships are detailed in relation to the structure of the invention (such that the invention can be used, maintained, or the like in a preferred manner). Pet bed system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different storage combinations, parts may be sold separately, etc., may be sufficient.

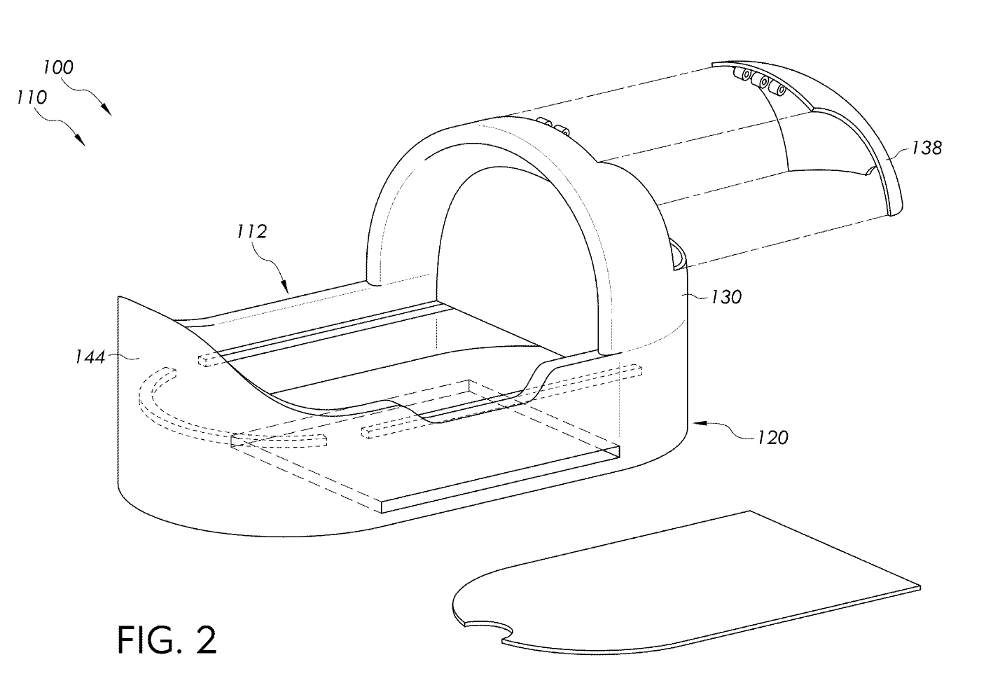

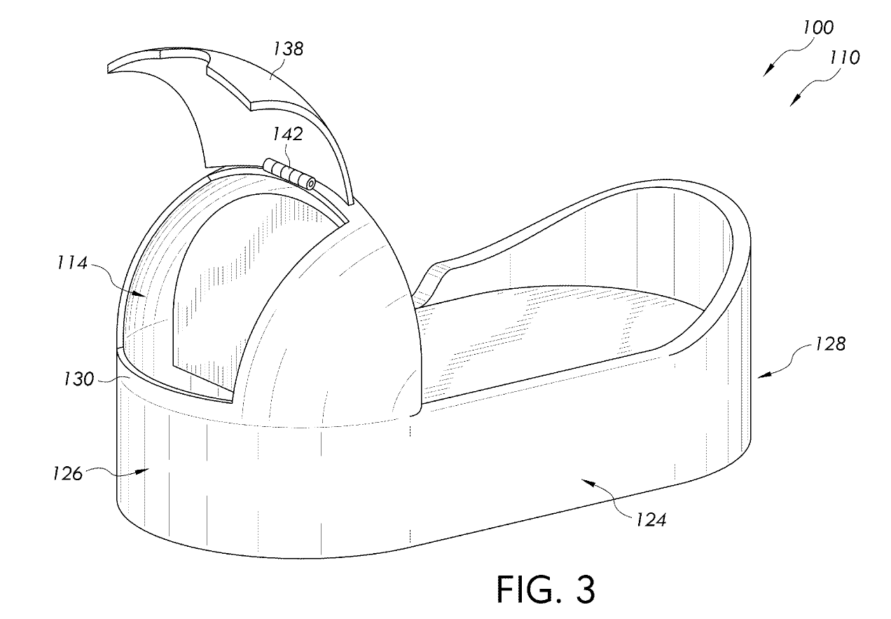

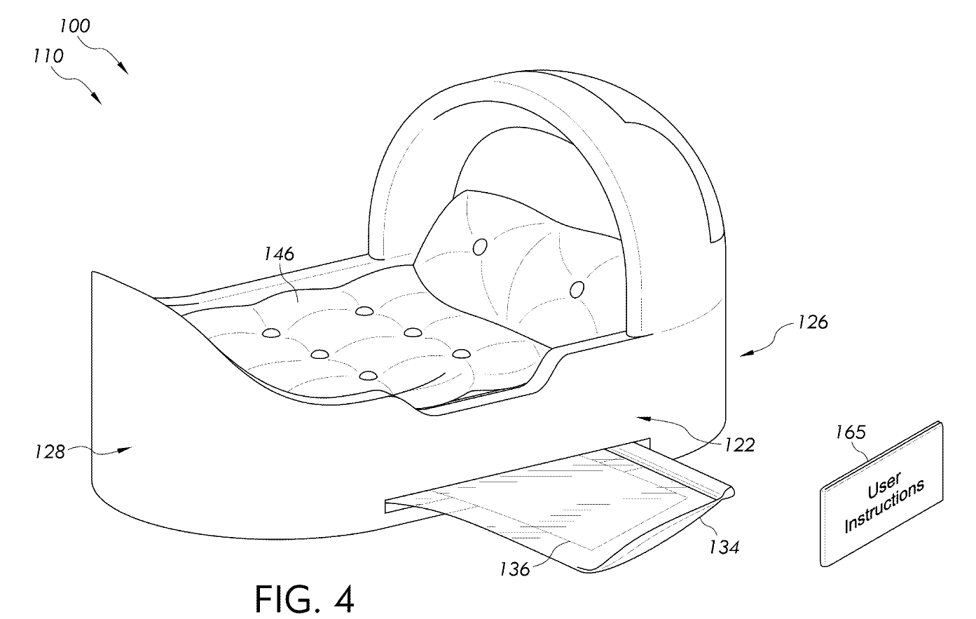

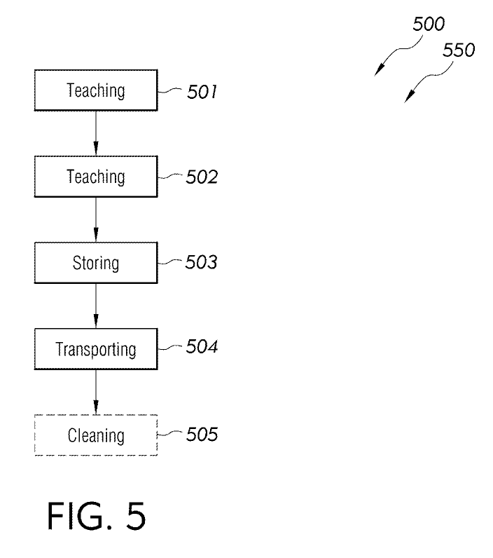

Referring now to FIG. 5 showing flowchart 550 illustrating method of use 500 for pet bed system 100 according to an embodiment of the present invention of FIGS. 1-4. As shown, method of use 500 may comprise the steps of: step one 501, teaching pet 132 to sleep in pet bed assembly 110; step two 502, teaching pet 132 where to find and access toys on pet bed assembly 110; step three 503, storing items related to pet 132 in three designated compartments; step four 504, transporting pet bed assembly 110 with pet 132 when needed; and step five 505, cleaning pet bed assembly 110 as needed.

It should be noted that step 505 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pet bed system comprising:
a pet bed assembly comprising;
a frame comprising;
a first-compartment;
a second-compartment; and
a third-compartment;
a base comprising;
a first-side;
a second-side;
a third-side; and
a fourth-side;
wherein said pet bed system comprises said pet bed assembly;
wherein said pet bed assembly comprises said frame, comprising said first-compartment, said second-compartment, said third-compartment, and said base defined by said first-side, said second-side, said third-side, and said fourth-side;
wherein said first-compartment comprises a crescent-shaped toy storage providing easy access to toys;
wherein said second-compartment is hidden within said frame for storage of medication prescribed to a pet;
wherein said third-compartment comprises a reseal-able plastic envelope suitable to contain paperwork for said pet which is flush with said frame to prevent accidental removal by said pet; and
wherein said pet bed assembly, said frame, and said base are structured and arranged to provide a complete storage system for said pet which is transportable from place to place with all necessities needed by said pet.

2. The pet bed system of claim 1 wherein said crescent-shaped toy storage comprises a lid which opens from a bottom of said base for ease of access to pet toys.

3. The pet bed system of claim 2 wherein said lid comprises a removable hinge such that said lid detaches from said crescent-shaped toy storage for ease of cleaning.

4. The pet bed system of claim 3 wherein said lid comprises said removable hinge such that said lid detaches from said crescent-shaped toy storage for replacement.

5. The pet bed system of claim 1 wherein said third-compartment containing said resealable plastic envelope stores an entirety of records for said pet.

6. The pet bed system of claim 1 wherein said reseal-able plastic envelope protects said entirety of records for said pet.

7. The pet bed system of claim 1 wherein said second-compartment is constructed as a false bottom for storing extra blankets.

8. The pet bed system of claim 1 wherein said second-compartment is constructed as a false bottom for storing clothing suitable for wear by said pet.

9. The pet bed system of claim 1 wherein said second-compartment is constructed as a false bottom for storing a leash for said pet.

10. The pet bed system of claim 1 wherein said pet bed assembly is constructed from rigid plastic such that said pet bed assembly is easy to clean via wiping.

11. The pet bed system of claim 1 wherein said pet bed assembly is constructed from rigid plastic such that said pet bed assembly is durable and washable in use.

12. The pet bed system of claim 1 wherein said second-compartment is constructed as a false bottom for storing a raincoat of said pet.

13. The pet bed system of claim 1 wherein said second-compartment is constructed as a false bottom for storing a harness of said pet.

14. The pet bed system of claim 1 wherein said second-compartment is constructed as a false bottom for storing waste disposal bags for use by said pet.

15. The pet bed system of claim 1 wherein said frame defines an area for bedding material.

16. The pet bed system of claim 1 wherein said second-compartment is disposed above a plane of said third-compartment within said frame.

17. A pet bed system comprising:
a pet bed assembly comprising;
a frame comprising;
a first-compartment;
a second-compartment; and
a third-compartment;
a base comprising;
a first-side;
a second-side;
a third-side; and
a fourth-side;
wherein said pet bed system comprises said pet bed assembly;
wherein said pet bed assembly comprises said frame, comprising said first-compartment, said second-compartment, said third-compartment, and said base defined by said first-side, said second-side, said third-side, and said fourth-side;
wherein said frame defines an area for bedding material;
wherein said pet bed assembly is constructed from rigid plastic such that said pet bed assembly is easy to clean via wiping;
wherein said pet bed assembly is constructed from rigid plastic such that said pet bed assembly is durable and washable in use;
wherein said first-compartment comprises a crescent-shaped toy storage providing easy access to toys;
wherein said crescent-shaped toy storage comprises a lid which opens from a bottom of said base for ease of access to pet toys;
wherein said lid comprises a removable hinge such that said lid detaches from said crescent-shaped toy storage for ease of cleaning;
wherein said lid comprises said removable hinge such that said lid detaches from said crescent-shaped toy storage for replacement;
wherein said second-compartment is hidden within said frame for storage of medication prescribed to a pet;
wherein said second-compartment is constructed as a false bottom for storing extra blankets;
wherein said second-compartment is constructed as a false bottom for storing a raincoat of said pet;
wherein said second-compartment is constructed as a false bottom for storing a harness of said pet;
wherein said second-compartment is constructed as a false bottom for storing clothing suitable for wear by said pet;
wherein said second-compartment is constructed as a false bottom for storing a leash for said pet;
wherein said second-compartment is constructed as a false bottom for storing waste disposal bags for use by said pet;
wherein said second-compartment is disposed above a plane of said third-compartment within said frame;
wherein said third-compartment comprises a reseal-able plastic envelope suitable to contain paperwork for said pet which is flush with said frame to prevent accidental removal by said pet;
wherein said third-compartment containing said reseal-able plastic envelope stores an entirety of records for said pet;
wherein said reseal-able plastic envelope protects said entirety of records for said pet;
wherein said pet bed assembly, said frame, and said base are structured and arranged to provide a complete storage system for said pet which is transportable from place to place with all necessities needed by said pet.

18. The pet bed system of claim 17 further comprising a kit including:
said pet bed assembly;
said lid to cover said crescent-shaped toy storage;
said resealable plastic envelope;
a set of said bedding material; and
a set of user instructions.

19. A method of using a pet bed system comprising the steps of:
teaching a pet to sleep in a pet bed assembly;
teaching said pet where to find and access toys on said pet bed assembly;
storing items related to said pet in three designated compartments; and
transporting said pet bed assembly with said pet when needed.

20. The method of claim 19 further comprising the step of:
cleaning said pet bed assembly as needed.
